(19) United States
(12) Patent Application Publication
(10) Pub. No.: US 2008/0203700 A1
(43) Pub. Date: Aug. 28, 2008

(54) Bicycle frame assembly having a replaceable shock absorber

(75) Inventor: Chieh-Fu Tseng, Kaohsiung City (TW)

Correspondence Address: Paul D. Greeley;Ohlandt, Greeley, Ruggiero & Perle, L.L.P., 10th Floor, One Landmark Square, Stamford, CT, 06901-2682, US

(73) Assignee: ADVANCED INTERNATIONAL MULTI-TECH CO., LTD.

(21) Appl. No.: 12/069,787

(22) Filed: Feb. 13, 2008

(30) Foreign Application Priority Data
Feb. 15, 2007 (TW) 096105736

(51) Int. Cl. B62K 3/02; F16F 13/00

(52) U.S. Cl. 280/283; 267/140.11

(57) ABSTRACT

A bicycle frame assembly includes at least one frame member having a connecting portion, and at least one shock absorber formed as a looped plate member disposed detachably in the connecting portion. The looped plate member has two resilient plate portions each having two opposite ends, and an intermediate portion between the opposite ends. The resilient plate portions are interconnected at the opposite ends. The intermediate portions of the resilient plate portions extend away from each other.

### CROSS-REFERENCE TO RELATED APPLICATION

This application claims priority of Taiwanese Application No. 096105736, filed on Feb. 15, 2007.

### BACKGROUND OF THE INVENTION

1. Field of the Invention

This invention relates to a bicycle frame, more particularly to a bicycle frame assembly having a replaceable shock absorber.

2. Description of the Related Art

A currently available bicycle frame generally has an air or oil cylinder, or a polyurethane (PU) or metal spring that serves as a shock-absorbing mechanism. However, the shock-absorbing mechanism that is made from one of the aforementioned configurations has a complicated design, and has many components, so that not only is assembly of the shock-absorbing mechanism difficult, but also the cost is high. Further, the aforementioned shock-absorbing mechanism is heavy, so that the entire weight of the bicycle frame is increased. Thus, a strenuous effort is required during riding of the bicycle. Additionally, after assembly of the aforementioned shock-absorbing mechanism, it is difficult to adjust the shock-absorbing effect of the shock-absorbing mechanism or to replace the shock-absorbing mechanism with another shock-absorbing mechanism so as to suit the present road conditions.

### SUMMARY OF THE INVENTION

Therefore, one object of the present invention is to provide a bicycle frame assembly having a shock absorber which has a simple structure and which can be easily assembled and disassembled to facilitate replacement with another shock absorber.

Another object of the present invention is to provide a shock absorber for a bicycle frame which has a simple structure and which is easy to assemble.

According to one aspect of this invention, a bicycle frame assembly comprises a bicycle frame including at least one frame member that has a connecting portion, and at least one shock absorber formed as a looped plate member disposed detachably in the connecting portion. The looped plate member has two resilient plate portions. Each of the resilient plate portions has two opposite ends, and an intermediate portion between the opposite ends. The resilient plate portions are interconnected at the opposite ends. The intermediate portions of the resilient plate portions extend away from each other.

According to another aspect of this invention, a shock absorber for a bicycle frame comprises a looped plate member adapted to be disposed detachably in a frame member of the bicycle frame. The looped plate member has two resilient plate portions. Each of the resilient plate portions has two opposite ends, and an intermediate portion between the opposite ends. The resilient plate portions are interconnected at the opposite ends. The intermediate portions of the resilient plate portions extend away from each other.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a bicycle frame assembly according to the first preferred embodiment of this invention;

FIG. 2 is a fragmentary exploded perspective view of the first preferred embodiment;

FIG. 3 is a fragmentary perspective view of an alternative form of the first preferred embodiment;

FIG. 4 is a fragmentary perspective view of a bicycle frame assembly according to the second preferred embodiment of this invention;

FIG. 5 is a fragmentary perspective view of a bicycle frame assembly according to the third preferred embodiment of this invention;

FIG. 6 is a perspective view of a frame member of a bicycle frame assembly according to the fourth preferred embodiment of this invention with a shock absorber removed for clarity's sake;

FIG. 7 is a sectional view of an alternative form of the shock absorber of the fourth preferred embodiment;

FIG. 8 is a sectional view of another alternative form of the shock absorber of the fourth preferred embodiment;

FIG. 9 is a sectional view of yet another alternative form of the shock absorber of the fourth preferred embodiment;

FIG. 10 is a graph of amplitude of vibration versus time of a front fork of a conventional bicycle and a front fork of the bicycle frame assembly of the fourth preferred embodiment;

FIG. 11 is a sectional view of a shock absorber of a bicycle frame assembly according to the fifth preferred embodiment of this invention;

FIG. 12 is a graph of amplitude of vibration versus time of a front fork of a conventional bicycle and a front fork of the bicycle frame assembly of the fifth preferred embodiment;

FIG. 13 is a perspective view of a frame member of a bicycle frame assembly according to the sixth preferred embodiment of this invention;

FIG. 14 is a perspective view of an alternative form of the frame member of the bicycle frame of the seventh preferred embodiment; and

FIG. 15 is a perspective view of a bicycle frame assembly according to the eighth preferred embodiment of this invention.

### DETAILED DESCRIPTION OF THE PREFERRED EMBODIMENTS

Before the present invention is described in greater detail, it should be noted that the same reference numerals have been used to denote like elements throughout the specification.

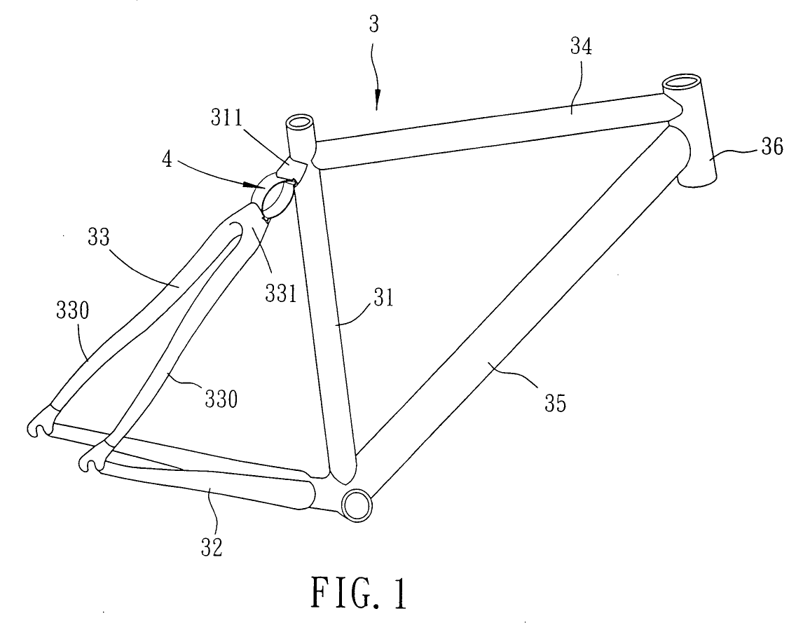

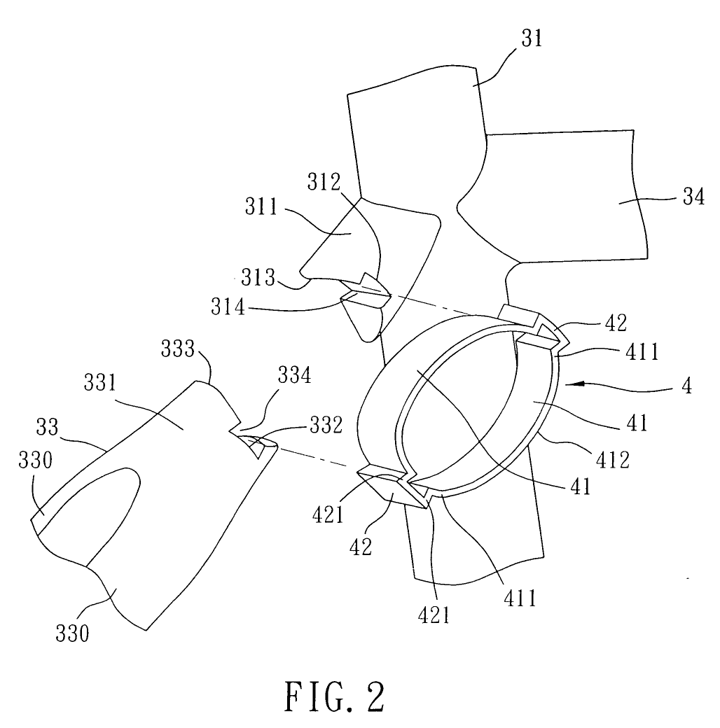

Referring to FIGS. 1 and 2, a bicycle frame assembly according to the first preferred embodiment of the present invention is shown to comprise a bicycle frame 3 and a shock absorber 4.

The bicycle frame 3 includes a plurality of frame members 31, 32, 33, 34, 35, 36. Since the shock absorber 4 is connected detachably between the frame members 31 and 33 in this embodiment, only the frame members 31 and 33 will be described herein. The frame member 31 has a rear connecting end 311 with a concaved end face 313 extending transversely thereof, and a connecting portion 312 having a groove 314 that extends inwardly from a middle of the concaved end face 313 and that is constricted at the concaved end face 313. The frame member 33 has a front connecting end 331 with a concaved end face 333 extending transversely thereof, and a connecting portion 332 having a groove 334 that extends inwardly from a middle of the concaved end face 333 and that is constricted at the concaved end face 333. Each of the grooves 314 and 334 has a dovetail-shaped cross section. In this embodiment, the frame member 33 is a rear fork of the bicycle frame 3, and has two spaced-apart prongs 330 interconnected at top ends thereof. The connecting portion 331 is disposed proximate to the top ends of the prongs 330.

The shock absorber 4 is made of a plate, and is disposed between the end faces 313, 333 of the frame members 31 and 33. The shock absorber 4 is formed as a looped plate member having two resilient plate portions 41 and two engaging bent plate portions 42. Each of the resilient plate portions 41 has two opposite ends 411, and an intermediate portion 412 between the two opposite ends 411. The intermediate portions 412 of the resilient plate portions 41 are convexed outwardly, and extend away from each other. The resilient plate portions 41 are interconnected at the opposite ends 411. Each of the engaging bent plate portions 42 protrudes outwardly from the resilient plate portions 42, and is bent to have a substantially U-shape which has opposite arms bent inwardly thereby forming a dovetail-shape complementary to the groove 314, 334. Each engaging bent plate portion 42 has two opposite ends 421 connected convergingly and respectively to one end 411 of one of the resilient plate portions 41 and one end 411 of the other one of the resilient plate portions 41. The engaging bent plate portions 42 of the shock absorber 4 are detachably and respectively interlocked with the grooves 314 and 334.

In this embodiment, the bicycle frame 3 and the shock absorber 4 are made of carbon fiber. However, in actual practice, they may be made of a material selected from the group consisting of a fiber composite, a magnesium alloy, an aluminum alloy, an aluminum-magnesium alloy, an aluminum-scandium alloy, atitanium alloy, and a combination thereof. The fiber composite may contain a fiber material, such as carbon fiber, Kevlar fiber, basalt fiber, and glass fiber.

To assemble the shock absorber 4 on the bicycle frame 3, the resilient plate portions 41 of the shock absorber 4 are first pressed toward each other, after which the engaging bent plate portions 42 of the shock absorber 4 are fitted snugly and respectively in the grooves 314 and 334 by moving the shock absorber 4 transversely to the frame members 31 and 33 so that the engaging bent plate portions 42 slide into the grooves 314 and 334. The resilient plate portions 41 are then released, so that they will restore to their original positions. At this time, the concaved end faces 313, 333 of the frame members 31 and 33 abut respectively against portions of the resilient plate portions 41 that are adjacent to the engaging bent plate portions 42, and the engaging bent plate portions 42 are also restored to their original positions so as to respectively abut against the grooves 314 and 334.

The shock absorber 4 may be replaced with another shock absorber 4 having a different coefficient of elasticity by pressing the resilient plate portions 41 of the shock absorber 4 toward each other, after which they are pushed transversely relative to the frame members 31 and 33 until the engaging bent plate portions 42 are disengaged from the respective grooves 314 and 334.

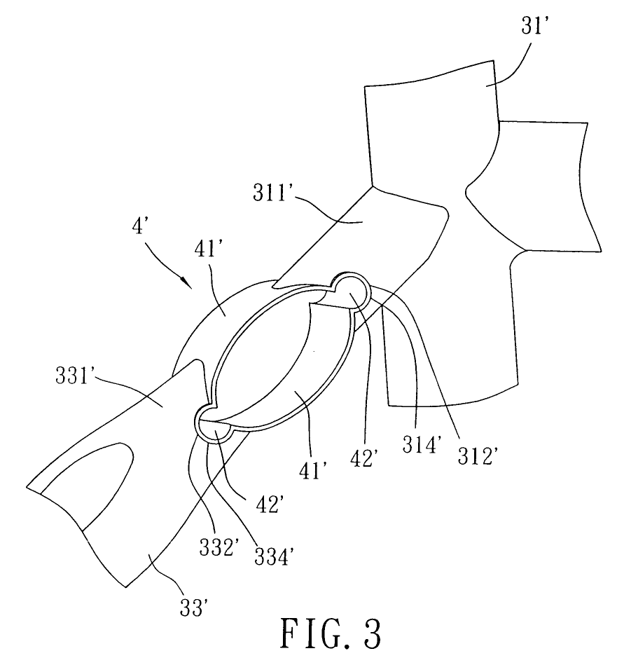

In this embodiment, the connecting portions 312, 332 of the frame members 31 and 33 are respectively formed with dovetail grooves 314, 334, and the engaging bent plate portions 42 of the shock absorber 4 have dovetail-shapes to engage complementarily, respectively, and detachably the dovetail grooves 314 and 334. However, in actual practice, the connecting portions 312′, 332′ may be provided respectively with grooves 314′, 334′ having a C-shaped cross section, and the engaging bent plate portions 42′ may be bent so as to be C-shaped complementary to the respective C-shaped grooves 314′, 334′, as shown in FIG. 3, so as to be fitted snugly in the grooves 314′, 334′. As long as the engaging bent plate portions 42 and the connecting portions 312, 332 can be interconnected detachably and respectively, any configuration of the engaging bent plate portions 42 and the connecting portions 312, 332 is acceptable.

Furthermore, since the resilient plate portions 41 of the shock absorber 4 are deformable, the frame members 31 and 33 can move relatively to a limited extent so as to provide a shock-absorbing effect. As such, the vibration generated by a rear wheel of a bicycle is absorbed and is minimized by the shock absorber 4. Because the shock absorber 4 has a relatively simple structure and is lightweight, the cost of the shock absorber 4 and the weight of the bicycle frame 3 are reduced to a minimum. Additionally, because the shock absorber 4 is easily assembled and disassembled, the user can change the shock absorber 4, as desired, with another shock absorber 4 having a different coefficient of elasticity to suit different road conditions. In actual practice, the number of the shock absorber 4 may be increased as required, and may be connected detachably between different parts of the bicycle frame 3.

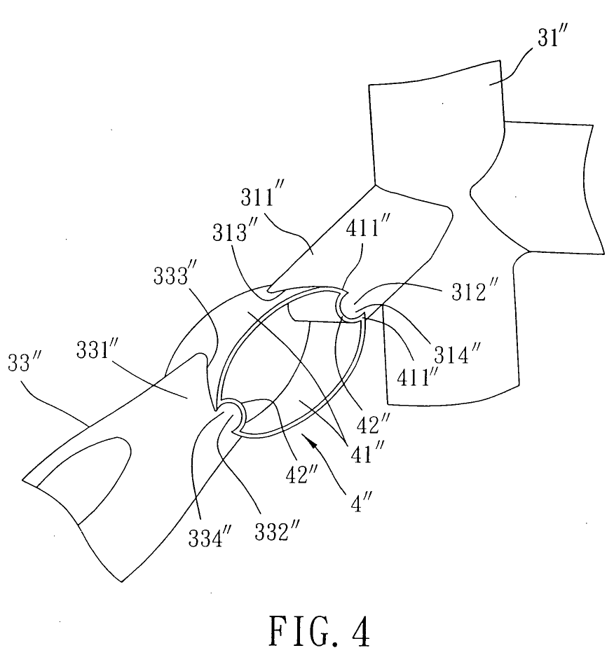

Referring to FIG. 4, a bicycle frame assembly according to the second preferred embodiment of the present invention is shown to be similar to the first preferred embodiment. However, in this embodiment, each connecting portion 312″, 332″ of the frame members 31″ and 33″ is formed as a rib 314″, 334″ having a C-shaped cross section, and projects outwardly from a middle of the concaved end face 313″, 333″ of the respective frame member 31″, 33″. Each engaging bent plate portion 42″ of the shock absorber 4″ extends in between the ends 411″ of the resilient plate portions 41″, and is bent to have a C-shaped groove complementary to the rib 314″, 334″ so as to fit snugly to the rib 314″, 334″. Assembly and disassembly of the shock absorber 4″ to and from the frame members 31″ and 33″ are similar to those described in the first preferred embodiment.

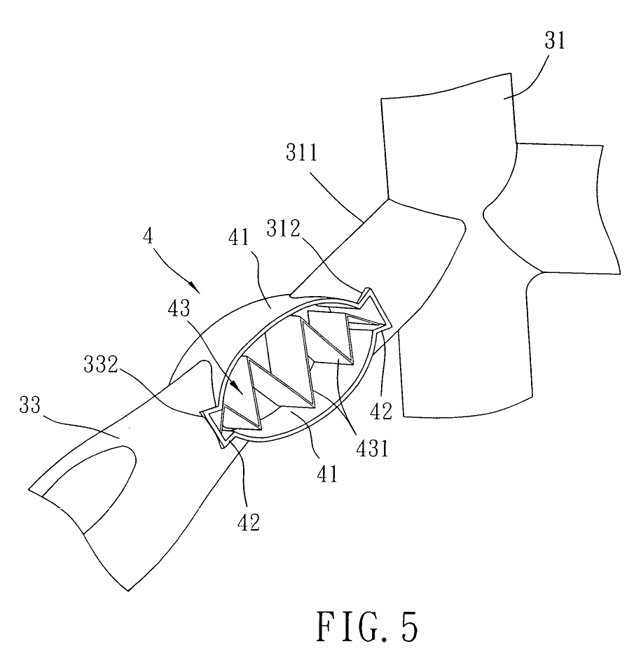

Referring to FIG. 5, a bicycle frame assembly according to the third preferred embodiment of the present invention is shown to be similar to the first preferred embodiment. However, in this embodiment, the shock absorber 4 further has a buffer plate 43 disposed between the resilient plate portions 41 and having two opposite ends connected respectively to inner faces of the engaging bent plate portions 42. In this embodiment, the buffer plate 43 has a wavy shape formed with a plurality of deformable bent portions 431. Through the presence of the wavy-shaped buffer plate 43, the structural supporting strength and the coefficient of elasticity of the shock absorber 4 are simultaneously enhanced.

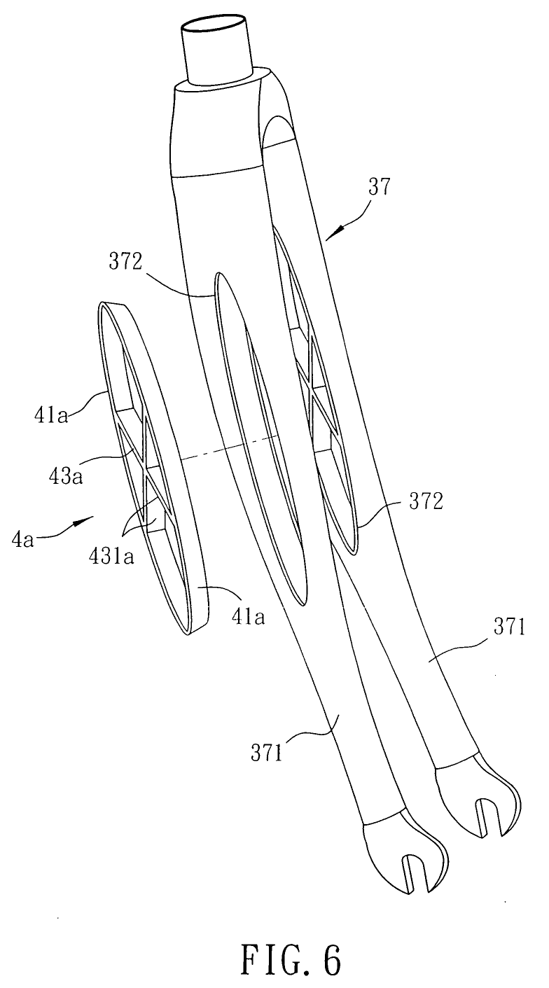

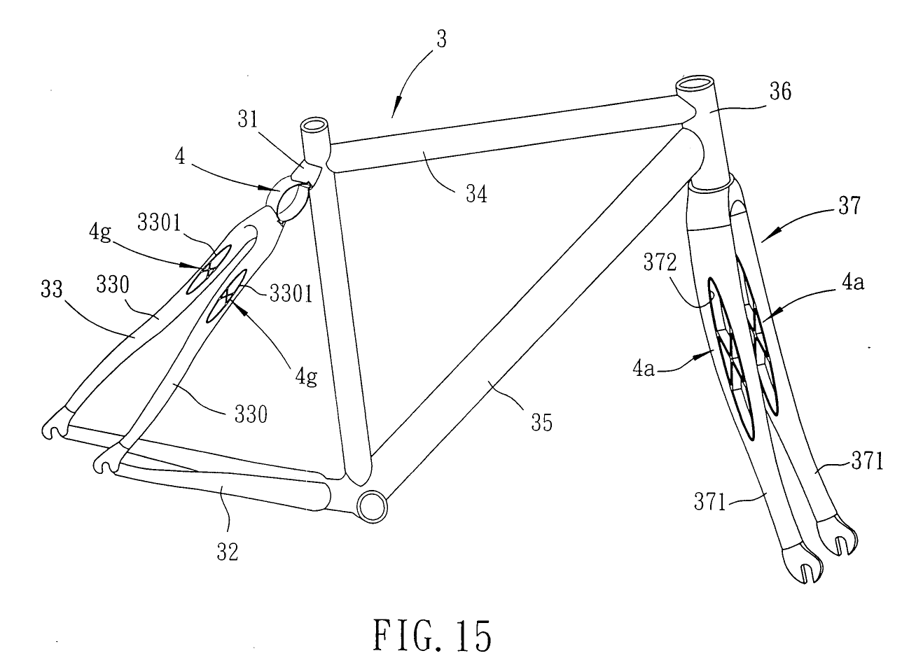

Referring to FIG. 6, a bicycle frame assembly according to the fourth preferred embodiment of the present invention is shown to comprise a frame member 37 of the bicycle frame 3, which is a front fork of the bicycle frame 3 (see FIG. 15), and two shock absorbers (4a). The frame member 37 is connected to the frame member 36 (see FIGS. 1 and 15), which is a head tube of the bicycle frame 3, and includes two spaced-apart prongs 371 interconnected at top ends thereof. Each prong 371 is provided with a connecting portion 372. The connecting portion 372 is configured as an elongated through hole formed in each prong 371. Each shock absorber (4a) includes two resilient plate portions (41a) connected integrally to each other so as to form a one-piece body, and a buffer plate (43a) connected between the resilient plate portions (41a). The resilient plate portions (41a) of each shock absorber (4a) are fitted detachably in the through hole or connecting portion 372 of the respective prong 371.

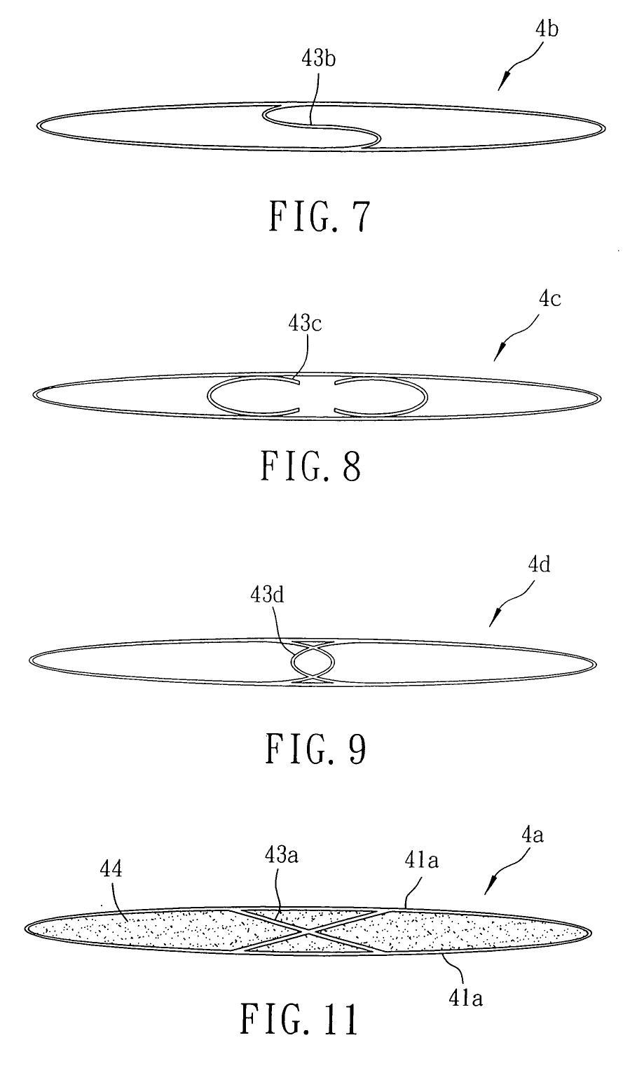

In this embodiment, the buffer plate (43a) has a shape resembling the letter “X,” and has two deformable bent portions (431a), and four ends connected to inner faces of the resilient plate portions (41a). Alternatively, the buffer plate (43b) may have a shape resembling the letter “S,” as shown in FIG. 7, which has two deformable bent portions. In another alternative embodiment, the shock absorber (4c) is provided with two buffer plates (43c), one of which has a shape resembling the letter “C,” and the other one of which has a shape resembling the reversed letter “C,” as shown in FIG. 8. Each buffer plate (43c) has a deformable bent portion. In still another alternative embodiment, the buffer plate (43d) has a shape resembling two intersecting letters of “C,” as shown in FIG. 9, and has two deformable bent portions.

To assemble each shock absorber (4a) on the respective prong 371 of the frame member 37, the resilient plate portions (41a) of each shock absorber (4a) is pushed forcibly into the through hole or connecting portion 372 of the respective prong 371 until the resilient plate portions (41a) abut against a wall defining the through hole 372. When changing of each shock absorber (4a) is required, the shock absorber (4a) is simply pushed out of the respective through hole or connecting portion 372. Since the shock absorbers (4a) are disposed respectively and detachably on the prongs 371 of the frame member 37, the prongs 371 provide a shock-absorbing effect. As such, the vibration generated by a front wheel of a bicycle is minimized and is absorbed by the shock absorber (4a).

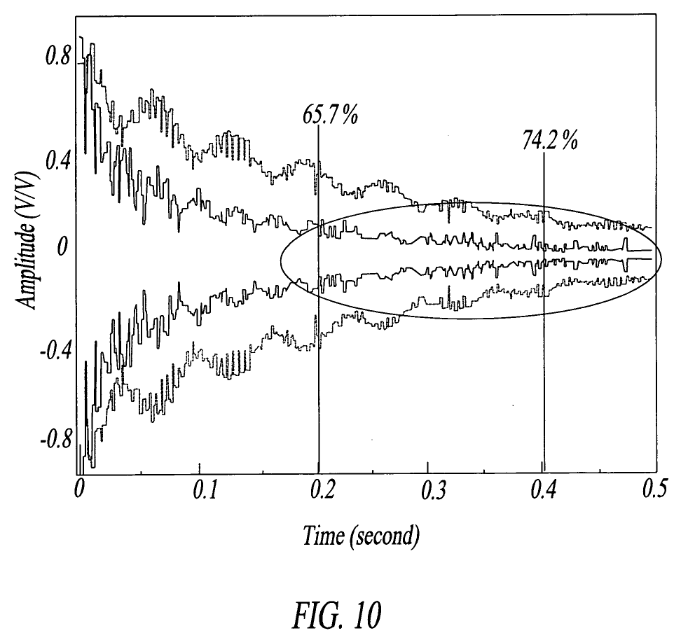

FIG. 10 is a graph that compares the vibrations generated in a front fork of a conventional bicycle frame and the front fork or frame member 37 of the fourth preferred embodiment. The front fork of each of the conventional bicycle frame and the fourth preferred embodiment is struck, and an accelerometer is used to measure their vibration accelerations. The measured vibration accelerations are illustrated in terms of voltage change. Further, the largest value of the voltage is set at “1” and the attenuation of the vibration acceleration varies in relation to time.

The y-ordinate represents the ratio of the voltages of the front fork of each of the conventional bicycle frame and the fourth preferred embodiment (v/v), while the x-ordinate represents time (in seconds) measured from the beginning of the impact. The black lines illustrate the vibration-time graph of the front fork of the conventional bicycle frame, while the red lines illustrate the vibration-time graph of the front fork 37 of the fourth preferred embodiment. It is apparent that after 0.2 seconds from the beginning of an impact, the vibration of the front fork 37 of the fourth preferred embodiment is reduced by 65.7% as compared to that of the front fork of the conventional bicycle frame. And after 0.4 seconds, the vibration thereof is reduced by 74.2% as compared to that of the front fork of the conventional bicycle frame. Accordingly, by directly disposing the shock absorber (4a) on the front fork 37, the vibration generated by the front fork 37 is minimized.

Referring to FIG. 11, a bicycle frame assembly according to the fifth preferred embodiment of the present invention is shown to be similar to the fourth preferred embodiment. However, in this embodiment, a shock-absorbing filler 44 is filled between the resilient plate portions (41a), thereby enhancing the shock-absorbing effect of the front fork 37 (see FIG. 6) of the bicycle frame 3 (see FIG. 15). The shock-absorbing filler 44 is made of a deformable rubbery material, such as foamed or non-foamed rubber.

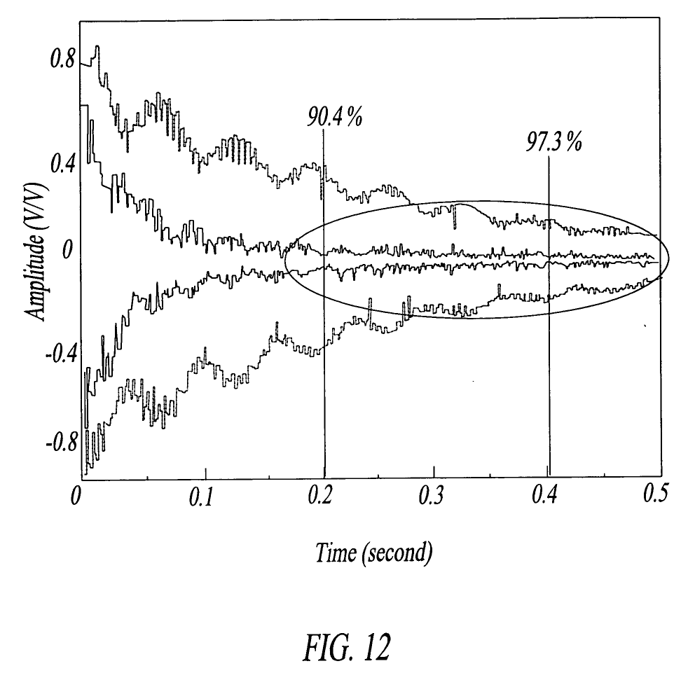

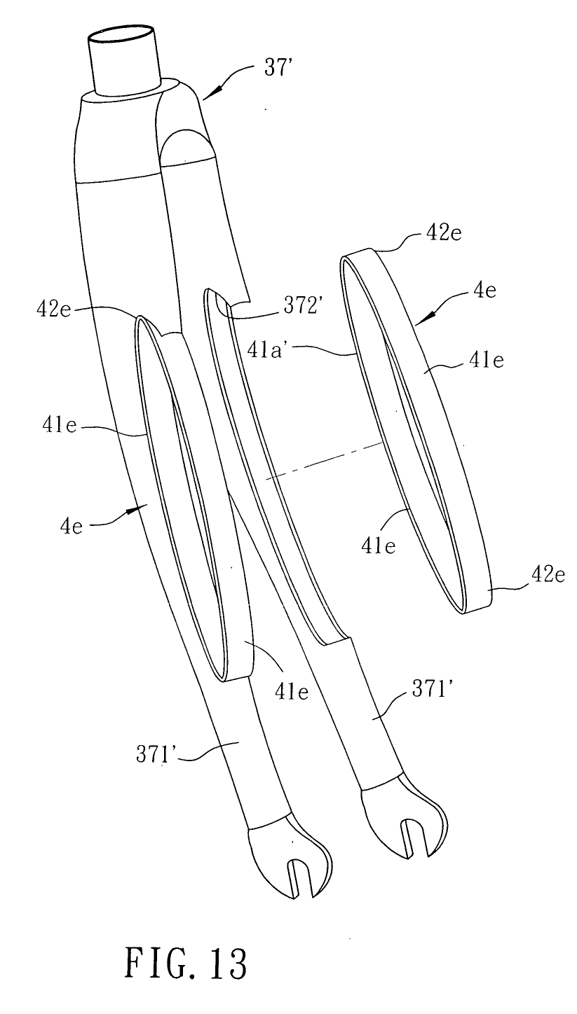

FIG. 12 is a graph that compares the vibrations generated in a front fork of a conventional bicycle frame and the front fork 37 of the fifth preferred embodiment. The black lines illustrate the vibration-time graph of the front fork of the conventional bicycle frame, while the red lines illustrate the vibration-time graph of the front fork 37 of the fifth preferred embodiment. It is apparent that after 0.2 seconds from the beginning of an impact, the vibration of the front fork 37 of the fifth preferred embodiment is reduced by 90.4% as compared to that of the front fork of the conventional bicycle frame. And after 0.4 seconds, the vibration thereof is reduced by 97.3% as compared to that of the front fork of the conventional bicycle frame. Accordingly, through the presence of the shock-absorbing filler 44, not only is the extent of vibration of the front fork 37 reduced, but also the shock-absorbing effect of the entire bicycle frame 3 is enhanced.

Referring to FIG. 13, a bicycle frame assembly according to the sixth preferred embodiment of the present invention is shown to be similar to the fourth preferred embodiment. However, in this embodiment, the connecting portion 372′ or each prong 371′ of the front fork 37′ is formed as a cutout portion. Each of the shock absorbers (4e) has two resilient plate portions (41e), and two engaging bent plate portions (42e) connected integrally between the resilient plate portions (41e). Each shock absorber (4e) is configured as an elliptical loop. The connecting portion 372′ or each prong 371a′ has a curvature that matches that of the respective shock absorber (4e). To assemble the shock absorbers (4e) on the respective prongs 371′, the engaging bent plate portions (42e) of each shock absorber (4a) is inserted fittingly and detachably into the cutout portion or connecting portion 372′ of the respective prong 371′.

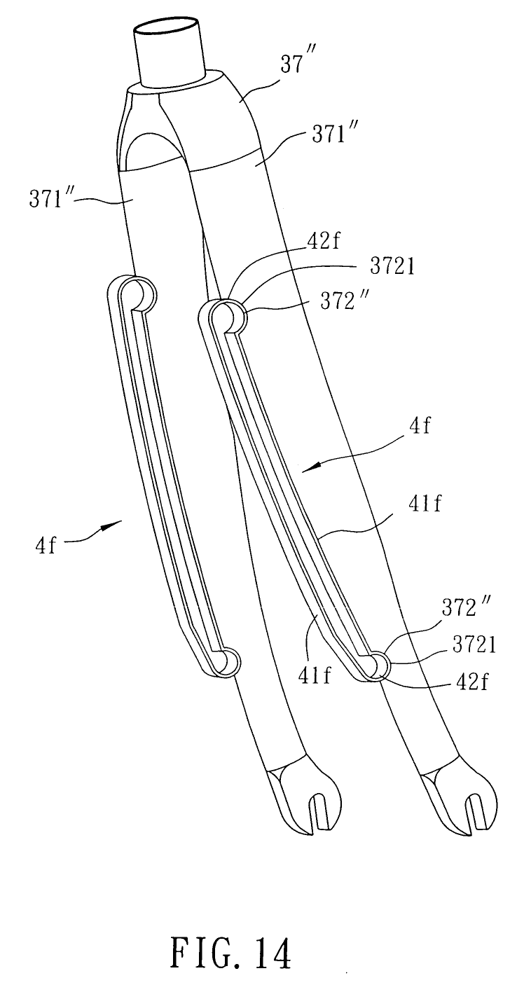

Referring to FIG. 14, a bicycle frame assembly according to the seventh preferred embodiment of the present invention is shown to be similar to the sixth preferred embodiment. However, in this embodiment, each of the connecting portions 372″ of the prongs 371″ has two grooves 3721 spaced apart from each other along the length of the respective prong 371″. The resilient plate portions (41f) of each shock absorber (4f) are substantially parallel, and the engaging bent plate portions (42f) are curved so as to engage detachably and respectively the grooves 3721 of the connecting portions 372″.

Referring to FIG. 15, a bicycle frame assembly according to the eighth preferred embodiment of the present invention is shown to be similar to the first preferred embodiment. However, in this embodiment, each of the rear prongs 330 of the frame member 33 has a connecting portion 3301 configured as a through hole, and is provided with a shock absorber (4g) which is connected detachably to the through hole or connecting portion 3301. The frame member 37 of the fourth preferred embodiment is connected to the frame member 36 of the bicycle frame 3. The advantages of the first to sixth preferred embodiments can be similarly achieved using the eighth preferred embodiment.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A bicycle frame assembly, comprising:
a bicycle frame including at least one frame member that has a connecting portion; and
at least one shock absorber formed as a looped plate member disposed detachably in said connecting portion, said looped plate member having two resilient plate portions, each of said resilient plate portions having two opposite ends, and an intermediate portion between said two opposite ends, said resilient plate portions being interconnected at said opposite ends, said intermediate portions of said resilient plate portions extending away from each other.

2. The bicycle frame assembly of claim 1, wherein said shock absorber is integrally formed as a one-piece body, said intermediate portions of said resilient plate portions being convexed outwardly, said resilient plate portions converging at said opposite ends thereof.

3. The bicycle frame assembly of claim 2, wherein said connecting portion is configured as a hole, said resilient plate portions being fitted in said hole and abutting against a wall defining said hole.

4. The bicycle frame assembly of claim 1, wherein said bicycle frame includes a pair of said frame members each having said connecting portion, said looped plate member further having two opposite engaging bent plate portions each having two opposite ends, each of said opposite ends of each of said engaging bent plate portions being connected to one of said opposite ends of one of said resilient plate portions, said opposite ends of said engaging bent plate portions converging to said opposite ends of said resilient plate portions, said engaging bent plate portions detachably and respectively interlocking with said connecting portions of said frame members.

5. The bicycle frame assembly of claim 4, wherein each of said frame members further has an end face extending transversely of a corresponding one of said frame members, said connecting portion being formed in said end face, said shock absorber being disposed between said end faces of said frame members.

6. The bicycle frame assembly of claim 5, wherein said end face is a concaved end face, said connecting portion having a groove that extends inwardly from a middle of said concaved end face, said groove being constricted at said concaved end face and receiving one of said engaging bent plate portions.

7. The bicycle frame assembly of claim 6, wherein said groove has a dovetail-shaped cross section, each of said engaging bent plate portions protruding outwardly from said resilient plate portions and being bent so as to be dovetail-shaped complementary to said groove.

8. The bicycle frame assembly of claim 6, wherein said groove has a C-shaped cross section, each of said engaging bent plate portions protruding outwardly from said resilient plate portions and being bent so as to be C-shaped complementary to said groove.

9. The bicycle frame assembly of claim 5, wherein said end face is a concaved end face, said connecting portion being formed as a rib that has a C-shaped cross section and that projects outwardly from a middle of said concaved end face, each of said engaging bent plate portions extending in between said resilient plate portions and being bent to have a C-shaped groove complementary to said rib.

10. The bicycle frame assembly of claim 3, wherein said frame member is a fork of said bicycle frame, and has two spaced-apart prongs, said hole being elongated and formed in each of said prongs, each of said prongs having said shock absorber disposed detachably in said hole.

11. The bicycle frame assembly of claim 1, wherein said resilient plate portions are substantially parallel, said looped plate member further having two opposite engaging bent plate portions, said opposite ends of each of said resilient plate portions being connected respectively to said engaging bent plate portions, said engaging bent plate portions detachably and respectively interlocking with said connecting portions of said frame members.

12. The bicycle frame assembly of claim 1, wherein said shock absorber further has a buffer plate disposed between said resilient plate portions and formed with at least one deformable bent portion.

13. The bicycle frame assembly of claim 1, wherein said shock absorber further has a shock-absorbing filler filled between said resilient plate portions, said shock-absorbing filler being made of a deformable rubbery material.

14. The bicycle frame assembly of claim 1, wherein each of said bicycle frame and said shock absorber is made of a material selected from the group consisting of a fiber composite, a magnesium alloy, an aluminum alloy, an aluminum-magnesium alloy, an aluminum-scandium alloy, a titanium alloy, and a combination thereof.

15. A shock absorber for a bicycle frame, comprising:
a looped plate member adapted to be disposed detachably in a frame member of the bicycle frame, said looped plate member having two resilient plate portions, each of said resilient plate portions having two opposite ends, and an intermediate portion between said opposite ends, said resilient plate portions being interconnected at said opposite ends, said intermediate portions of said resilient plate portions extending away from each other.

16. The shock absorber of claim 15, wherein said intermediate portions of said resilient plate portions are convexed outwardly, said resilient plate portions converging at said opposite ends thereof.

17. The shock absorber of claim 16, wherein said looped plate member further has two opposite engaging bent plate portions each having two opposite ends, each of said opposite ends of each of said engaging bent plate portions being connected to one of said opposite ends of one of said resilient plate portions, said opposite ends of said engaging plate portions converging to said opposite ends of said resilient plate portions.

18. The shock absorber of claim 17, wherein said engaging bent plate portions protrude outwardly from said opposite ends of said engaging bent plate portions.

19. The shock absorber of claim 17, wherein each of said engaging bent plate portions extends between said resilient plate portions.

20. The shock absorber of claim 16, wherein said looped plate member further has a buffer plate which is disposed between said resilient plate portions and which has at least one deformable bent portion.

21. The shock absorber of claim 16, wherein said looped plate member further has a shock-absorbing filler which is filled between said resilient plate portions and which is made of a deformable rubbery material.
